(19) United States
(12) Patent Application Publication
(10) Pub. No.: US 2015/0263596 A1
(43) Pub. Date: Sep. 17, 2015

(54) Linear Loudspeaker Motor

(71) Applicant: Lewis Athanas, Marblehead, MA (US)

(72) Inventor: Lewis Athanas, Marblehead, MA (US)

(21) Appl. No.: 14/214,641

(22) Filed: Mar. 14, 2014

(51) Int. Cl. H02K 41/035; H04R 7/04; H04R 1/42

(52) U.S. Cl. CPC H02K 41/0356; H04R 1/42; H04R 7/04

(57) ABSTRACT

A linear loudspeaker motor. A flat, relatively thin, rigid elongate motor armature is disposed in a gap between the north pole of one elongate magnet and the south of another elongate magnet, or a gap between the north and south poles of the same, or effectively the same, magnet. Several alternative means are provided to suspend the armature in the gap. The armature includes an elongate electrically conductive, low impedance strip. When a current flows in the strip, a force is produced that tends to move the elongate armature in or out of the gap, thereby displacing a loudspeaker diaphragm to which it is attached.

### CROSS REFERENCE TO RELATED APPLICATIONS

Applicant claims priority to U.S. Provisional Application No. 61/785,918, filed Mar. 14, 2013 and entitled “Loudspeaker With Synthesized Wavefront Output,” and to U.S. Provisional Application No. 61/802,289, filed Mar. 14, 2013 and entitled “Linear Loudspeaker Motor,” the entire contents of both of which are hereby incorporated into the present patent application by reference.

### FIELD OF THE INVENTION

The invention disclosed herein relates to drive motors for acoustic transducers and particularly to linear drive motors for loudspeakers and other acoustic transducers.

### BACKGROUND

Loudspeakers typically comprise a diaphragm driven by a circular moving coil. This driver, or motor, technology has been perfected over many decades. Reasons for the dominance this type of motor technology in the loudspeaker marketplace include efficiency, concise design based on the circular coil of wire in a magnetic gap, and that it is particularly suitable for cone and dome diaphragms.

However, as sound systems have become more miniaturized and embedded in products other than stand-alone music players, such as video and television products, a need for different form factors has arisen. Also, as speaker components have become smaller, the this dimensional spread of acoustic radiation has effectively become a point source. Consequently, it is common now to see multiple small loudspeakers arranged in a line to approximate a line source. This requires much expense and complexity of design.

Accordingly, there is also a need for a more suitable, linear speaker motor in many applications. For example, such a motor can make possible many attractive loudspeaker, and combination video and loudspeaker, designs from both an acoustic and industrial design point of view. Indeed, a linear motor may be integrated with an amplifier and ancillary electronics to expand such design possibilities.

### SUMMARY

A motor is disclosed for producing planar motion, comprising an elongate first magnet having a north and south poles extending along the elongate dimension of the first magnet; an elongate second elongate magnet having a north and south poles extending along the elongate dimension of the second magnet; a support member for holding the first magnet in relation to the second magnet so that their elongate dimensions are substantially parallel, opposite poles of the first magnet and the second magnet face one another, respectively, and a gap exists there between; and a substantially planar armature disposed in the gap between the first magnet and the second magnet, the armature having a driving portion adjacent one edge thereof and a flat, electrically-conductive element having an elongate dimension extending substantially parallel to the elongate axes of the magnets, such that when an electric current is caused to flow in the elongate dimension of the electrically-conductive element, a force is exerted on the planar armature in a translational direction parallel to a surface of the armature and perpendicular to the elongate axes of the magnets.

A method is disclosed for producing motion in a plane, comprising providing a U-shaped magnet having two sides separated by an elongate gap, having a north pole on one side the gap and a south pole on the other side of the gap; supporting an elongate substantially flat, rigid and movable armature within the gap; providing an elongate electrically-conductive strip disposed on the armature extending in the elongate dimension of the gap; and causing an electric current to flow in the strip so as to produce a magnetic field and concomitant force on the armature tending to move it in or out of the gap.

It is to be understood that this summary is provided as a means for generally determining what follows in the drawings and detailed description, and is not intended to limit the scope of the invention. The foregoing and other objects, features, and advantages of the invention will be readily understood upon consideration of the following detailed description taken in conjunction with the accompanying drawings.

### BRIEF DESCRIPTION OF THE DRAWINGS

FIG. 1 is a perspective of a first embodiment of a linear transducer motor according to principles disclosed herein, attached to a flat panel acoustic transducer diaphragm.

FIG. 2 is a cross section of a second embodiment of a linear transducer motor according to the principles disclosed herein.

FIG. 3 is a cross section of a third embodiment of a linear transducer motor according to the principles disclosed herein.

FIG. 4 is a cross section of a fourth embodiment of a linear transducer motor according to the principles disclosed herein.

### DETAILED DESCRIPTION

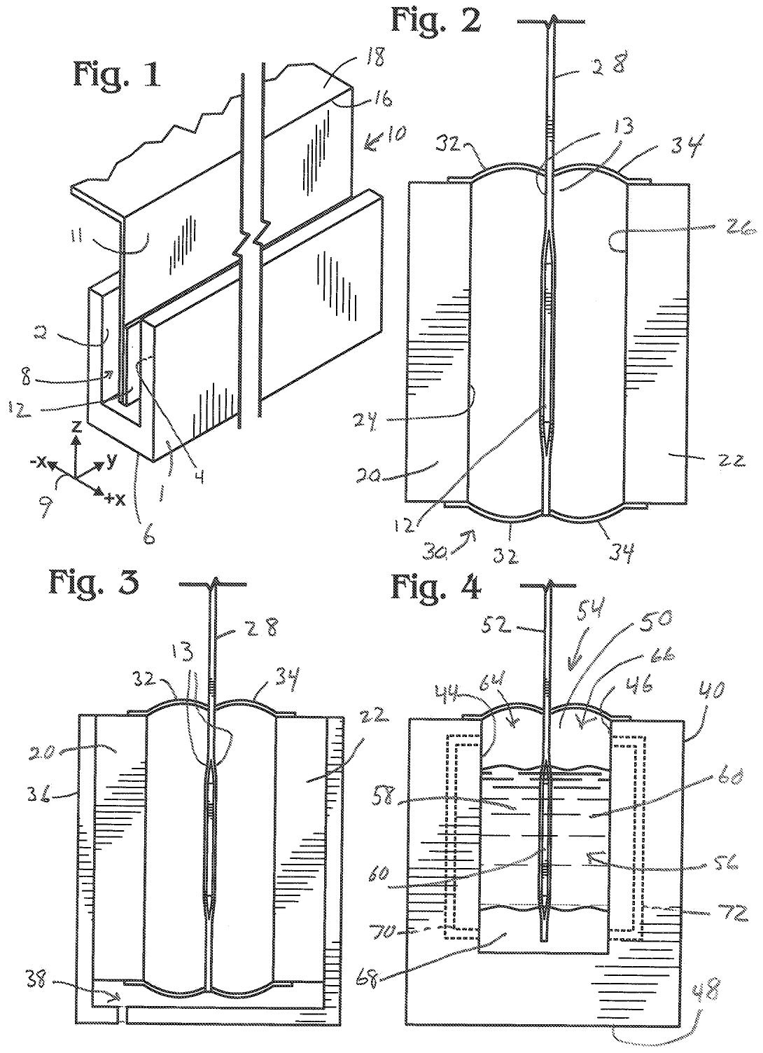

Various embodiments of a linear transducer motor that is particularly suitable for use with a stereo flat panel loudspeaker of the type shown in U.S. patent application Ser. No. 14/214,585 filed Mar. 14, 2014 and entitled Acoustic Transducer and Method for Driving Same (“Athanas 585”) are shown in FIGS. 1, 2, 3 and 4. This is because in that type of loudspeaker the goal is to produce linear transverse waves originating respectively from both the left and right edges of the panel, and concomitant approximately cylindrical longitudinal waves in the air. However, it is to be understood that the linear transducer disclosed herein may have application to other types of flat panel acoustics transducers and other devices as well.

Turning to FIG. 1, a first embodiment of a linear motor according to the inventive concepts comprises an elongate U-shaped magnet 1 having a north pole 2, a south pole 4, and an interconnecting portion 6 forming a long, fixed gap 8 between the north and south poles. For explanatory purposes, the lateral dimension of the magnet will be referred to as the X axis of a Cartesian coordinate system, the elongate dimension of the magnet will be referred to as the Y axis of the coordinate system, and the Z axis of the coordinate system runs through the center of the gap between the north pole 2 and south pole 4 of the magnet. The motor also comprises a linear armature 10 that is relatively thin in the dimension of the X axis, elongate in the dimension of the Y axis and disposed in the gap between the two poles such that the armature can move in and out of the gap in the dimension of the Z axis. The armature comprises a non-magnetic relatively flat, thin and rigid body member and an elongate, electrically-conductive strip of material 12 disposed one each side of the elongate body member, respectively. The material may be gold, copper, aluminum or some other appropriate conductor. In this embodiment the armature is connected to the edge 16 of a flat panel speaker diaphragm 18, described and explained in Athanas '585, which holds the armature between the poles of the magnet 1.

When a current flows through the conductive strips 12, the induced magnetic field interacts with the fixed magnetic field of magnet 1 to produce a force along the entire length of the armature 10 tending to push it out of or pull it into the gap 8. This in turn displaces the edge 16 of the speaker diaphragm 18, producing a transverse wave in the in the diaphragm originating at the edge 16.

FIG. 2 shows a second embodiment of a linear motor having unconnected magnets 20 and 22, the north pole of magnet 20 being at the right side 24 of the magnet and the south pole of magnet 22 being at the left side 26 of the magnet, with the south and north poles respectively located on the opposite sides of the magnets. In this case an armature 28 is also disposed between the north pole of one magnet and the south pole of the other magnet, not necessarily connected to a speaker diaphragm. Also in this case the conductive metal strip 12 is sandwiched between two pieces of non-magnetic relatively flat, thin and rigid material to form the armature. The armature is supported by an upper suspension device 28 and a lower suspension device 30, each of which is connected between the armature and the two magnets, to center the armature and keep ambient air pressure from leaking into the system. The magnets may be held in position by any appropriate mechanism that need not, but could, be a magnet flux conduction material.

Each suspension device has a left flexible, curved suspension member 32 attached between the left side of the armature and the right side of the magnet 20, and a right flexible, curved suspension member 34 attached between the left side of the armature and the right side of the magnet 20. In the suspension members in the upper suspension device are preferably convex upwardly, while in the lower suspension device the suspension members are preferable convex downwardly so as two be mirror images of one another and to keep unwanted matter from getting caught in the suspension members. However, it is to be understood that it would be consistent with the inventive principles of this disclosure if one or both pairs of the suspension members were curved in the opposite direction, or stretchable and not curved at all.

A further embodiment of a motor according to the inventive principles of this disclosure is shown in FIG. 3. This is like the embodiment of FIG. 2, except that the magnets 20 and 22 are held in place by a ferromagnetic frame 36. In this case, multiple spaced apertures 38 are formed along the length of the frame to equalize the air pressure both above and below the suspension devices.

Yet another, fourth embodiment of a motor according to the principles of this disclosure is shown in FIG. 4. Like the embodiment of FIG. 22, this embodiment comprises an elongate U-shaped magnet 40 having a north pole 44, a south pole 46, and an interconnecting portion 48 forming a long, fixed gap 50 between the north and south poles. The same Cartesian coordinate system used in FIG. 22 is used here. This further embodiment also comprises a linear armature 52 like that used in the embodiments of FIGS. 22-24. This embodiment further comprises an upper armature suspension device 54 as used in the embodiments of FIGS. 23 and 24. However, this embodiment employs a ferrofluid 56 to levitate the conductive strip in the center of the magnetic circuit, maintain the lateral position of the armature in the gap between the north and south poles of the magnet 40, cool the system and allow for much closer tolerances in the gap with increases efficiency.

The ferrofluid preferably comprises microscopic ferromagnetic particles that collectively behave like a fluid, but will aggregate together under the influence of a magnetic field so as to assume a collective shape that minimizes potential energy. An example of a suitable ferrofluid is described in Athanas U.S. Pat. No. 5,335,287, the entire contents of which are hereby incorporated by reference. Consequently, the ferrofluid forms symmetric portions 58 and 60 on opposite sides of the armature 252 substantially midway between the top and bottom of the gap, adjacent the respective conductive strips 60 and 62, thereby holding the armature in the center of the gap while it moves in the Z axis dimension in response to current flowing through the conductive strip 60 and 62. To ensure that the pressure in the chambers 64 and 66 formed above the ferrofluid portions 56 and below the suspension device 54 is equal to the pressure in the chamber 68 formed below the ferrofluid and within the walls of the magnet, two pressure equalizing passageways 70 and 72 are formed in the magnet between the north-side upper chamber 56 and lower chamber 68, and between the south-side upper chamber 66 and lower chamber 68, respectively.

The conductive strip in the motor embodiments of FIGS. 1-4 would ordinarily have a low resistance, on the order of 1 ohm, and be used with a low output-impedance, low-voltage, high-current drive circuit, as would be understood by a person skilled in the art.

It is to be understood that variations of the features of embodiments shown in FIGS. 1 4 may be used to form other embodiments without departing from the inventive concepts discussed in this disclosure. It is also to be understood that the linear motor disclosed herein may be used in applications other than a loudspeaker or other acoustic transducer without departing from those inventive concepts.

The terms and expressions which have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims that follow.

1. A motor for producing planar motion, comprising:
an elongate first magnet having a north and south poles extending along the elongate dimension of the first magnet;
an elongate second elongate magnet having a north and south poles extending along the elongate dimension of the second magnet;
a support member for holding the first magnet in relation to the second magnet so that their elongate dimensions are substantially parallel, opposite poles of the first magnet and the second magnet face one another, respectively, and a gap exists there between; and
a substantially planar armature disposed in the gap between the first magnet and the second magnet, the armature having a driving portion adjacent one edge thereof and a flat, electrically-conductive element having an elongate dimension extending substantially parallel to the elongate axes of the magnets,
such that when an electric current is caused to flow in the elongate dimension of the electrically-conductive element, a force is exerted on the planar armature in a translational direction parallel to a surface of the armature and perpendicular to the elongate axes of the magnets.

2. The motor of claim I, further comprising a magnetic conductor member disposed between the first magnet and the second magnet adjacent respective first elongate edges thereof so as to produce a high flux-density magnetic circuit between the two magnets, the planar armature extending between the second two opposite elongate edges of the respective magnets.

3. The motor of claim 2, further comprising at least one suspension member disposed between the two magnets and the armature to restrain movement of the armature primarily to said translational direction.

4. The motor of claim 3, comprising at least two such suspension members separated from one another in said translational direction.

5. The motor of claim 4, further comprising a vent between the magnetic conductor member and the closer of the suspension members for equalizing the air pressure on the exterior of both said suspension members.

6. The motor of claim 2, further comprising a ferrofluid disposed in the between the magnetic conductor member and said at least one suspension member to levitate the planar armature, a first air cavity being formed between the ferrofluid and said at least one suspension member, a second air channel being formed between the magnetic conductor member and the ferrofluid, and an air channel between formed between the first cavity and the second cavity to equalize the pressure in both cavities.

7. The motor of claim 1, further comprising at least one suspension member disposed between the two magnets and the armature to restrain movement of the armature primarily to said translational direction.

8. The motor of claim 7, comprising at least two such suspension members separated from one another in said translational direction.

9. The motor of claim 1, wherein the planar armature is coupled to a diaphragm for moving an acoustic fluid to produce acoustical waves in the fluid in response to a time varying current through the electrically-conductive element.

10. The motor of claim 9, wherein the diaphragm is quiescently substantially planar and oriented perpendicularly to the planar armature.

11. The motor claim 10, wherein the acoustical fluid is air and the varying of the current is in the audio frequency band so that the combination acts as a loudspeaker.

12. The motor of claim 9, wherein the diaphragm is quiescently substantially planar and coupled to the planar armature at an edge of the diaphragm and an edge of the armature, movement of the planar diaphragm in its planar dimension being at least partially constrained at a location separate from the armature so as to produce transverse waves in the diaphragm.

13. The motor of claim 12, wherein the acoustical fluid is air and the varying of the current is in the audio frequency so that the combination acts as a loudspeaker.

14. A method for producing motion in a plane, comprising:
providing U-shaped having two sides separated by an elongate gap, having a north pole on one side the gap and a south pole on the other side of the gap;
supporting an elongate substantially flat, rigid and movable armature within the gap;
providing an elongate electrically-conductive strip disposed on the armature extending in the elongate dimension of the gap; and
causing an electric current to flow in the strip so as to produce a magnetic field and concomitant force on the armature tending to move it in or out of the gap.
